(19) United States
(12) Patent Application Publication
(10) Pub. No.: US 2021/0399964 A1
(43) Pub. Date: Dec. 23, 2021

(54) DETECTING STATUS OF AN UPLINK IN A SOFTWARE DEFINEDWIDE AREA NETWORK

(71) Applicant: Hewlett Packard Enterprise Development LP, Houston, TX (US)

(72) Inventors: Gopal GUPTA, Bangalore (IN); Abhinesh MISHRA, Bangalore (IN); Ataur REHMAN, Bangalore (IN)

(21) Appl. No.: 17/225,856

(22) Filed: Apr. 8, 2021

(30) Foreign Application Priority Data
Jun. 19, 2020 (IN) IN 202041026001

(51) Int. Cl. H04L 12/26; H04L 12/28

(52) U.S. Cl. CPC H04L 43/0864; H04L 43/087; G06N 20/00; H04L 43/0817; H04L 12/2854

(57) ABSTRACT

Examples include detection of a status of an uplink in an SD-WAN. Some examples use a predicted probe profile determined based on predicted RTT values generated using a machine learning algorithm for estimating whether the uplink is failed. In response to estimating that the uplink is failed, some examples compute a confidence level value and determine whether the estimated failure of the uplink is acceptable based on the confidence level value to detect a status of the uplink.

### BACKGROUND

A wide area network (WAN) may extend across multiple network sites (e.g. geographical, logical). Sites of the WAN are interconnected so that devices at one site can access resources at another site. In some topologies, many services and resources are installed at core sites (e.g. datacenters, headquarters), and many branch sites (e.g. regional offices, retail stores) connect client devices (e.g. laptops, smartphones, internet of things devices) to the WAN. These types of topologies are often used by enterprises in establishing their corporate network.

Each network site has its own local area network (LAN) that is connected to the other LANs of the other sites to form the WAN. Networking infrastructure, such as switches and routers are used to forward network traffic through each of the LANs, through the WAN as a whole, and between the WAN and the Internet. Each network site's LAN is connected to the wider network (e.g. to the WAN, to the Internet) through a gateway router. Branch gateways (BGs) connect branch sites to the wider network, and head-end gateways (also known as virtual internet gateways) connect core sites to the wider network.

Often, WANs are implemented using software defined wide area network (SD-WAN) technology. SD-WAN may simplify the management and operation of a WAN by decoupling (separating) the networking hardware from its control mechanism. SD-WAN solutions may employ centrally managed WAN edge devices placed in branch offices to establish logical connections with other branch edge devices across a physical WAN.

### BRIEF DESCRIPTION OF THE DRAWINGS

For a more complete understanding of the present disclosure, examples in accordance with the various features described herein may be more readily understood with reference to the following detailed description taken in conjunction with the accompanying drawings, where like reference numerals designate like structural elements, and in which;

FIG. 1 is a block diagram of an example SD-WAN, including a branch gateway communicatively coupled to a headend gateway through an uplink, for detecting a status of the uplink;

FIG. 2A illustrates example network parameters of an uplink, in SD-WAN, determined and recorded in response to probing performed using an example probe profile;

FIG. 2B illustrates an example dataset including predicted RTT values determined based on RTT values of an uplink gathered over two hours from an instant of time;

FIG. 3 illustrates an example dataset for computing confidence level values in peak hours and off-peak hours;

FIG. 4 illustrates an example processing circuitry executing instructions for detecting a status of an uplink in SD-WAN; and

FIG. 5 is a flowchart illustrating an example method for detecting a status of an uplink in SD-WAN.

### DETAILED DESCRIPTION

A BG may include multiple uplinks to the broader WAN for sending application traffic based on the application's requirement. These uplinks may provide diversity across technology (e.g. MPLS versus DSL), provider, and geography (based on the provider's network). The uplinks also provide high availability (redundancy if a subset of the uplinks go down) and increase total bandwidth. If an uplink goes down, the applications may switchover to other uplinks in order to maintain uninterrupted service.

BG may periodically evaluate each uplink, in the SD-WAN, to assess their health and ensure quality of service (QoS) as network conditions change. If an uplink is not healthy enough to meet a service level agreement (SLA) between BG and an application, that describes minimum health for good operation of the application, the uplink may be determined to be failed. In such instances, the application may migrate to a healthier uplink in order to maintain uninterrupted service.

In order to gauge an uplink's health, BG actively probes the uplink by sending probe packets through the uplink. Generally, probing uses a predefined probe profile (e.g., a static probe profile) that defines a number of probes (including retries), probe interval and a wait time. A probe interval may be a time interval between two probes such that no intervening probe is sent between the two probes. That is, expiration of probe interval may trigger sending the probe again. The duration of the probe interval may vary, for example, from milliseconds to minutes. A response may be received in reply to a probe within the probe interval. For each probe, network parameters of the uplink may be determined in order to keep a track of the health of the uplink. Examples of the network parameters that may be determined may include jitter, RTT, latency, packet-loss, throughput and bandwidth. A probe retry value may define a number of times probes may be sent before declaring failure of the uplink. Wait time may define a total time elapsed (or a time limit) in performing probing as per a probe profile before detecting failure of the uplink.

BG may confirm that an uplink's health is good when a response to probing is received within a wait time while performing probing. When BG does not receive a response to probing, BG may assess the uplink's health to be bad (i.e., not good enough to meet an application's SLA) and the uplink is detected as failed.

Since the static probe profile may not adapt to an uplink's changing health, available detection methods may not get a sense of accurate uplink's health. For example, in a scenario, BG may not receive response to probing within the wait time as per the static probe profile, due to traffic congestion in certain times of day or week, and detected failure of the uplink. This detection of uplink's failure may cause unnecessary migration of applications among uplinks, which may be detrimental for the operation of the applications and reduce QoS.

In the present disclosure, BG may estimate, using a predicted probe profile, whether an uplink in an SD-WAN is failed. A SD-WAN device may dynamically determine the predicted probe profile based on the learnings of the behavior of the uplink in a predetermined period of time. In the examples described herein, the SD-WAN device may determine the predicted probe profile based on predicted RTT values of the uplink using a machine learning algorithm. SD-WAN device may gather RTT values of the uplink for a predetermined period of time such as hours, days or weeks and generate predicted RTT values based on the gathered RTT values. BG may receive the predicted probe profile and perform probing of the uplink using the predicted probe profile for estimating whether the uplink is failed. For example, BG may determine whether a response to the probing is not received in a predicted wait time in accordance with the predicted probe profile to estimate that the uplink is failed.

Then, BG may compute a confidence level value based on one or more network parameters including RTT, jitter or packet loss of the uplink. The confidence level value may represent accuracy of the estimated failure of the uplink. In an example, BG computes the confidence level value based on baseline values of RTT and jitter. Based on the confidence level value, BG may determine whether the estimated failure of the uplink is acceptable to detect a status of the uplink. For example, BG may determine that the estimated failure of the uplink is acceptable when the confidence level value is higher than a predetermined threshold value of confidence level for an application, and thereby detect that a status of the uplink is failed. In another example, BG may determine that the estimated failure of the uplink is not acceptable when the confidence level value is lower than a predetermined threshold value of confidence level for an application, and thereby detect that the status of the uplink is not failed.

BG may periodically receive predicted probe profile and estimate, using the predicted probe profile, whether the uplink is failed. In response to estimating that the uplink is failed, BG computes a confidence level value that represents accuracy of the estimated failure of the uplink and thereby detect a status of the uplink. Thus, the present disclosure advantageously provide more accurate status of an uplink as compared to available detection methods.

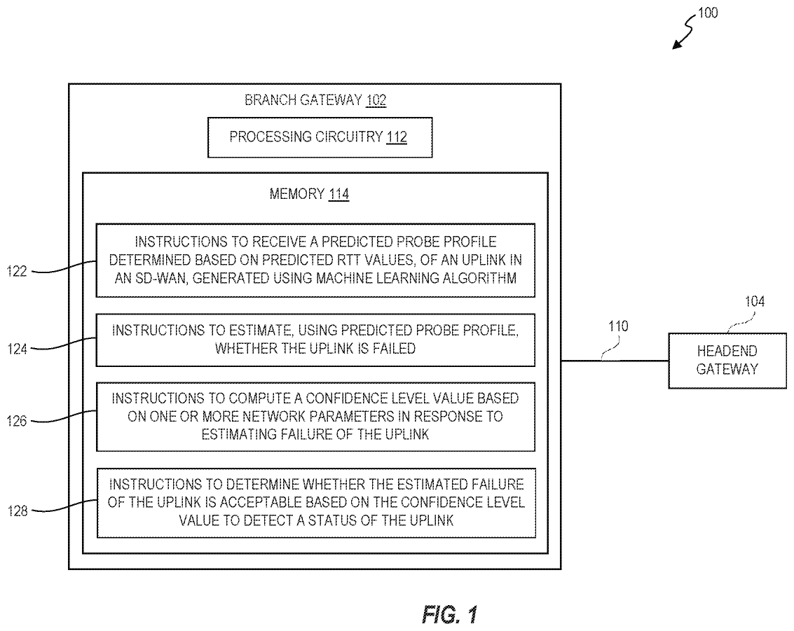

FIG. 1 illustrates an example SD-WAN 100 in which a branch gateway is communicatively coupled to a headend gateway through an uplink. SD-WAN 100 includes a branch gateway (BG) 102 and a headend gateway 104 communicatively coupled to the branch gateway 102 through uplink 110. Although a single uplink 110 is shown in FIG. 1, SD-WAN 100 may include more than one uplinks between branch gateway 104 and the headend gateway 104.

BG 102 may communicate with the headend gateway 104 over a computer network. The computer network may be a wireless or wired network. The computer network may include, for example, a Wide Area Network (WAN), a Metropolitan Area Network (MAN), a Storage Area Network (SAN), a Campus Area Network (CAN), or the like. Further, the computer network may be a public network (for example, the Internet) or a private network

The headend gateway 104 may transceive data relating to one or more applications, which are transported in SD-WAN 100 through the uplink 110. The headend gateway 104 may be referred to as a destination endpoint that receive the data. In an example, the headend gateway 104 may be an endpoint for an SD-WAN device Layer 3 Virtual Private Network (L3VPN) overlay based on Internet Protocol Security (IPsec) tunneling. In order to establish a secure communication channel between the BG 102 and the headend gateway 104, a protocol, such as Internet Protocol Security (IPsec) may be used.

IPsec is a network protocol suite that authenticates and encrypts the packets of data sent over a network. IPsec, for example, may extend private networks through creation of encrypted tunnels which secure site to site connectivity across untrusted networks. IPsec may protect data flows between a pair of hosts, between a pair of security gateways, or between a security gateway and a host. An IPsec tunnel may allow encrypted IP traffic to be exchanged between the participating entities.

In an example, headend gateway 104 may be a part of a datacenter network or a campus network. In an example, the headend gateway 104 may act as a VPN concentrator (VPNC) and run at the headend in hub-and-spoke and multi hub-and-spoke topologies. A VPN concentrator may provide a secure creation of VPN connections and delivery of messages between VPN nodes. The headend gateway 104 may act as a terminating point for IPsec VPN tunnels. The headend gateway 104 may be located, for example, at headquarter or a data center of an enterprise.

BG 102 may communicate with the headend gateway 104 through the uplink 110 as illustrated in FIG. 1. The uplink 110 may be wired or wireless. In an example, the uplink 140 may be based on Multiprotocol Label Switching (MPLS), 4G LTE, or 5G LTE. In some other examples, the uplink 110 may use another communication technology such as Digital Subscriber Line (DSL) etc. In an example, the network traffic via the uplink 110 may terminate at the headend gateway 104.

BG 102 may provide the functionality to detect a status of the uplink 110. In an example, the BG 102 may be capable of detecting status of the uplink 110 at a real-time basis. The status detection functionality of the BG 102 may be described in detail with reference to the FIGS. 1-5.

BG 102 may include a processing circuitry 112 and a memory 114 communicatively coupled through a system bus. Processing circuitry 112 may be any type of Central Processing Unit (CPU), microprocessor, or processing logic that interprets and executes machine-readable instructions stored in memory 114. Memory 114 may be a random access memory (RAM) or another type of dynamic storage device that may store information and machine-readable instructions that may be executed by processing circuitry 112. For example, memory 114 may be Synchronous DRAM (SDRAM), Double Data Rate (DDR), Rambus DRAM (RDRAM), Rambus RAM, etc. or storage memory media such as a floppy disk, a hard disk, a CD-ROM, a DVD, a pen drive, and the like. In an example, memory 114 may be a non-transitory machine-readable medium.

In an example, memory 114 may store machine-readable instructions (i.e. program code) 122, 124, and 126 that, when executed by the processing circuitry 112, may at least partially implement some or all functions of BG 102.

Instructions 122 may be executed by BG 102 to receive a predicted probe profile determined based on predicted RTT values, of the uplink 110, generated using a machine learning algorithm. In an example, the predicted probe profile may be received from a management device present in SD-WAN 100 or a cloud system coupled to the SD-WAN 100. The management device may include any combination of hardware and programming to implement the functionalities of the management device as described herein. In an example, the management device may store and execute machine-executable instructions stored in a processing circuitry communicatively coupled to a memory. Memory may be a non-transitory, computer-readable medium including instructions that, when executed by processing circuitry, cause the device to undertake certain actions. In some examples, the management device may be a service or application executing on one or more computing devices in SD-WAN or cloud computing device(s). The management device may be provided to the SD-WAN 100 as a service (aaS).

Cloud system may be a private cloud, a public cloud, or a hybrid cloud. The cloud system may be used to provide or deploy various types of cloud services. These may include Infrastructure as a Service (IaaS), Platform as a Service (PaaS), Software as a Service (SaaS), and so forth.

The management device may receive or gather information that includes network parameters of the uplink 110 over a predetermined period of time. The predetermined period of time may range from hours or days defined by an administrator. The predetermined period of time may be defined depending on peak hours or off-peak hours, deployment type based on geolocations, topology, QoS, sensitivity of applications etc. The data so gathered may be referred to as “training data” and leveraged to predict a probe profile (i.e., predicted probe profile). The gathered data (or training data) may include one or more network parameters determined during probing over the predetermined period of time. The network parameter(s) determined during probing may include jitter, RTT, and packet-loss. Packet-loss may represent a number of packets that are lost or a response to which is not received w.r.t a total number of packets sent during probing. Packet-loss may also be represented in terms of packet received i.e. a number of packets received w.r.t. a total number of packets sent during probing.

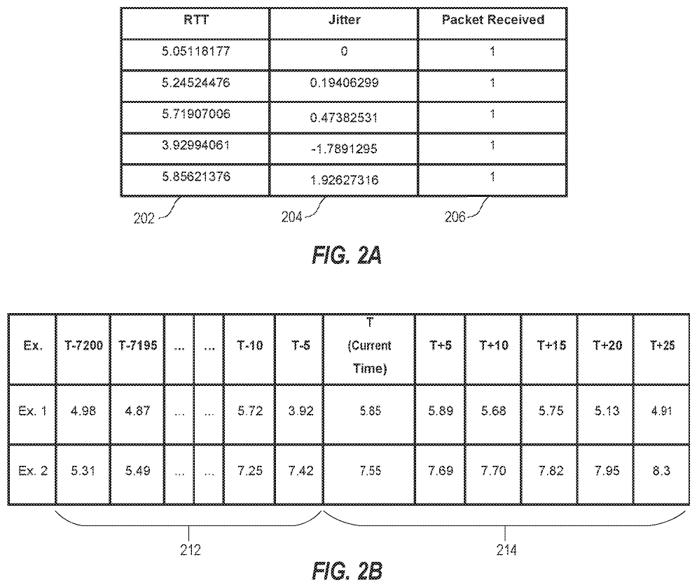

FIG. 2A shows example values of network parameters—RTT value 202, jitter value 204 and packet-received 206 determined in response to a probe profile where 5 probes were sent at the probe interval of 5 seconds. In this example, a value ‘1’ of packet received 206 means that a response is received in response to sending a packet, and hence packet-loss is ‘0.’

Once data is gathered about RTT values, the management device may use a machine learning algorithm to generate predicted RTT values. In an example, the machine learning algorithm may be a time series model. Examples of the time series model may include Long-Short Term Memory neural set (LSTM) model, Auto Regressive Integrated Moving Average (ARIMA) model, Gated Recurrent Unit (GRU) model etc. In certain examples, the predicted RTT values may be determined using LSTM model.

The management device may generate a number of predicted RTT values equal to the probe retry value as defined in probe profile used while probing the uplink 110 in the predetermined period of time. FIG. 2B shows examples of five predicted RTT values 214 determined based on training data including RTT values 212 gathered over last two hours from current time (T) using LSTM model. In FIG. 2B, example 1 (Ex. 1) corresponds to off-peak hours and example 2 (Ex. 2) corresponds to peak hours. For each example, a probe profile including 5 probes (probe retry value) with 5 second time interval was used for probing. In each example, training data includes 1440 records gathered in last two hours (i.e., 7200 seconds) as the probes were sent at every 5 second probe interval This training data (including 1440 records of RTT values 212) of last two hours was used to predict next five RTT values 214. In FIG. 2B, the data before the current time (T) belong to training data and the data shown after the current time (T) includes five predicted RTT values 214 in Ex. 1 and Ex. 2.

Based on the predicted RTT values, the device may determine a predicted wait time. In an example, the predicted wait time may be calculated using equation 1.

Predicted wait time=Number of predicted RTT values×Max predicted RTT value Equation 1

Where, Max predicted RTT value is a maximum RTT value observed out of the predicted RTT values.

In some examples, a predicted probe retry value may be determined depending on the probe interval. The predicted probe retry value may be calculated using equation 2.

Predicted probe retry value=Predicted Wait time/probe interval Equation 2

By tailoring probe interval, the predicted probe retry value may be adjusted for the predicted probe profile to be used for probing.

Once the information about the predicted probe profile is received by BG 102, instructions 124 may be executed by BG 102 to estimate, using the predicted probe profile, whether the uplink 110 is failed. In order to estimate whether the uplink 110 is failed, BG 102 may perform probing using the predicted probe profile and determine whether a response to probing the uplink 110 is received in accordance with the predicted probe profile. Performing probing may include sending probes through the uplink 110 in accordance with the predicted probe profile. For example, BG 102 may perform probing as per calculated probe retry value (equation 2). BG 102 may perform probing until the expiration of the predicted wait time. BG 102 may determine whether a response to probing the uplink 110 is received in the predicted wait time (as calculated using equation 1). In instances when a response to probing is received in the predicted wait time, BG 102 does not estimate failure of the uplink 110. In instances when no response to probing is received in the predicted wait time, BG 102 estimates that the uplink 110 is failed.

Upon expiration of the predicted wait time, BG 102 may receive a successive predicted probe profile generated based on training data gathered for a successive period of time from a time stamp of the expiration of the previous predicted wait time. In an example, the successive probe profile may be predicted at an instant of time, when probing initiates according to successive predicted probe profile. The successive predictive probe profile may continue until the expiration of the successive predictive wait time.

A predetermined period of time may be measured from an instant of time (e.g., a first instant of time) when probing initiates (or immediately before the probing initiates) according to the predicted probe profile.

In response to estimating failure of the uplink 110, instructions 126 may be executed by BG 102 to compute a confidence level value. The confidence level value may represent accuracy of the estimated failure of the uplink 110. The confidence level value may be computed based on one or more network parameters. The network parameters may include RTT, jitter, latency, packet-loss, bandwidth-utilization, etc. In an example, BG 102 may compute a confidence level value based on packet-loss, RTT and jitter.

BG 102 may calculate the confidence level value using a baseline value of the one or more network parameter(s). In the examples described herein, the confidence level value may be computed using baseline values of RTT (i.e., RTT baseline value) and jitter (i.e., jitter baseline value).

A baseline value of a network parameter may be determined using a baselining algorithm. In an example, the baselining algorithm may be based on factors, for example, mean, median, most frequent value, maximum value, or one-class support vector machine. In an example, the baselining algorithm may use values observed over a period of time for a network parameter with respect to an uplink. The baselining algorithm may use a dataset comprising values of the network parameter recorded over a period of time to get baseline value of that network parameter. For example, baseline values may be determined for network parameters jitter and RTT by running the baselining algorithm over the data gathered in a week. When a value of a network parameter is in negative deviation with the baseline value of that network parameter, the health of the uplink may be determined to be good.

In an example, the baseline value of a network parameter may be updated by executing the baselining algorithm at a regular interval which may vary, for example, from an hour to a week, or it may include another duration, as determined by a user. The values observed over a period of time for a network parameter with respect to an uplink may be stored, for example, on BG 102 and may be used for updating the baseline values of the network parameters at a regular interval.

In an example, BG 102 may calculate the confidence level value using equation 3.

Confidence level value=0.7×packet received (%)+0.2×RTT values in negative deviation (%)+0.1×Jitter values in negative deviation (%) Equation 3

Where, packet-received (%) represents percentage of probes to which a response is received while probing. Packet received (%) may be calculated using equation 4.

$$Packet received ( \% ) = \frac{No . of probes to which a response is received}{Total number of probes sent} \qquad Equation 4$$

RTT values in negative deviation (%) represents percentage of a number of probes to which RTT value is in negative deviation with RTT baseline value. RTT values in negative deviation (%) may be calculated using equation 5.

$$RTT values in negative deviation ( \% ) = \frac{\begin{matrix}No . of probes to which RTT value is in \\ negative deviation with RTT baseline value\end{matrix}}{Total number of probes sent} \qquad Equation 5$$

Jitter values in negative deviation (%) represents percentage of a number of probes to which jitter value is in negative deviation with the jitter baseline value. Jitter values in negative deviation (%) may be calculated using equation 6.

$$Jitter values in negative deviation ( \% ) = \frac{\begin{matrix}No . of probes to which jitter value is in \\ negative deviation with jitter baseline value\end{matrix}}{Total number of probes sent} \qquad Equation 6$$

Although the algorithm described in equation 3 is not the only way to determine a confidence level value for an uplink, equation 3 generates a confidence level value based on RTT and jitter of the uplink.

The confidence level value may be high or low. A high or low confidence level value for an uplink may be defined with respect to a predetermined threshold value of confidence level for an application. A predetermined threshold value of confidence level for an application may be a measure of the confidence level value for that application to estimate whether the uplink is failed (i.e., uplink' health is not good enough to meet application's SLA) for functioning that application through the uplink.

Once the confidence level value is calculated, instructions 128 may be executed by BG 102 to determine whether the estimated failure of the uplink 110 is acceptable based on the confidence level value to detect a status of the uplink 110. That is, a status of the uplink 110 may be detected based on the confidence level value. In some examples, the instructions 128 may further include instructions executed by BG 102 to determine whether the computed confidence level value is higher than a predetermined threshold value of confidence level for an application. Upon determining that the computed confidence level value is high (i.e., higher than the predetermined threshold value of confidence level for an application), BG 102 may determine that the estimated failure of the uplink 110 for that application is acceptable. In these instances, BG 102 may detect that a status of the uplink is failed. In such instances, the uplink 110 for the application may be declared dead and the application may be migrated to another uplink.

In some other examples, upon determining that the computed confidence level value is low (i.e., lower than the predetermined threshold value of confidence level), BG 102 may determine that the estimated failure of the uplink 110 for that application is not acceptable. In these instances, BG 102 may detect that a status of the uplink 110 is not failed. In such instances, the uplink 110 for the application may not be declared dead and the application may continue using the uplink 110. BG 102 may continue sending probes as per successive predicted probe profiles through the uplink 110 until the confidence level value reaches to the predetermined threshold value of confidence level for that application.

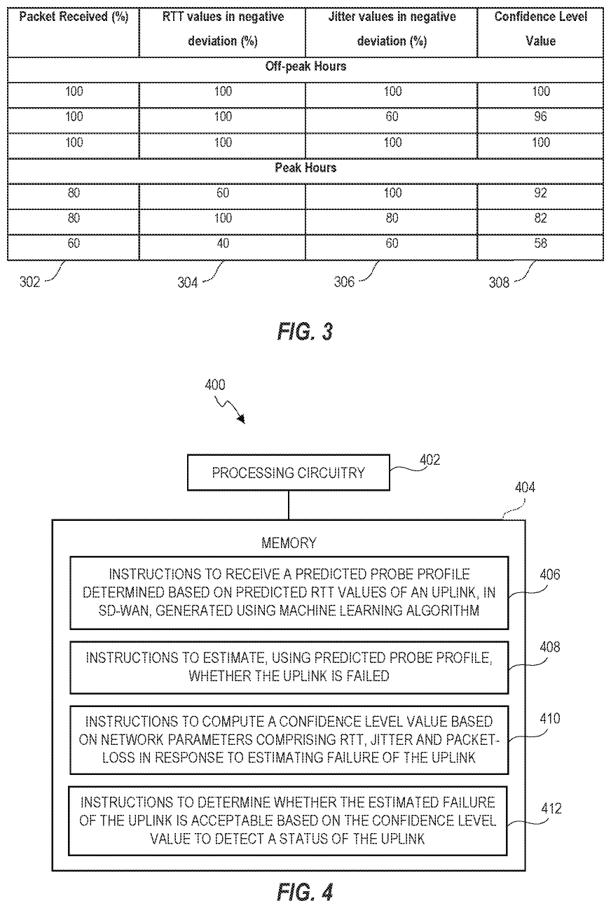

FIG. 3 illustrates sample dataset comprising packet received (%) 302, RTT values in negative deviation (%) 304 and jitter values in negative deviation (%) 306 and corresponding computed confidence level values 308 during off-peak hours and peak hours.

As shown in FIG. 3, confidence level values 308 during off-peak hours are high (e.g., higher than 80, which may a threshold confidence level for an application). During off-peak hours, if no response to the probes is received within the predicted wait time (determined using equation 1) then the estimated failure of an uplink for that application is acceptable. In such examples, it is detected that the status of the uplink is failed. In such examples, the uplink may be declared dead. Whereas during peak hour, the confidence level values 308 vary. During peak hours, if no response to the probes is received within the predicted wait time (determined using equation 1) then the estimated failure of the uplink may or may not be acceptable based on the confidence level value. For example, when the confidence level value is low (e.g., 58, which is much lower than 80), the estimated failure of the uplink cannot be accepted. In such examples, the status of the uplink is detected to be not failed.

FIG. 4 is a block diagram 400 depicting a processing circuitry 402 coupled to memory 404. Memory 404 is a non-transitory, computer-readable medium including instructions 406, 408, 410 and 412 (406-412) to detect a status of an uplink in an SD-WAN. The instructions 406-412 of FIG. 4, when executed by the processing circuitry 402, may implement some or all functions for detecting a status of an uplink. In an example, the processing circuitry 402 and the memory 404 may be included in (e.g., as part of) a BG (e.g., BG 102 of FIG. 1) in an SD-WAN. In an example, processing circuitry 402 may be analogous to processing circuitry 112 and memory 404 may be analogous to memory 114 of FIG. 1. In other examples, the processing circuitry 402 and the memory 404 may be included in (e.g., as part of) an SD-WAN device that controls the operation of an SD-WAN. In an example, SD-WAN device may be any server, computing device, dedicated hardware, virtualized device, or instead be a service or application executing on one or more computing devices

Instructions 406 may be executed to receive a predicted probe profile determined based on predicted RTT values, of an uplink in an SD-WAN, generated using a machine learning algorithm such as a time series model. In some examples, the predicted RTT values may be generated, using a time series model, based on data gathered Including RTT values of the uplink in a predetermined period of time. A predicted wait time and/or a predicted probe retry value may be determined based on the predicted RTT values using equations 1 and 2, respectively, to define the predicted probe profile.

Instructions 408 may be executed to estimate, using the predicted probe profile, whether the uplink 110 is failed. In some examples, instructions 408 may be executed to perform probing of the uplink using the predicted probe profile and determine whether a response to probing the uplink is received in the predicted wait time. When a response to probing the uplink is received in the predicted wait time, it may be estimated that the uplink is failed.

In response to estimated failure of the uplink, instructions 410 may be executed to compute a confidence level value. The confidence level value may be computed based on network parameters including RTT, jitter and packet-loss. In an example, the confidence level value may be calculated using equation 3.

Instructions 412 may be executed to determine whether the estimated failure of the uplink is acceptable based on the confidence level value to detect a status of the uplink. In instances when the confidence level value is high (i.e., higher than a predetermined threshold value of confidence level for an application), the estimated failure of the uplink is acceptable. In these examples, the status of the uplink is detected “failed.” In instances when the confidence level value is low (i.e., lower than a predetermined threshold value of confidence level for an application), the estimated failure of the uplink is not acceptable. In such examples, the status of the uplink 110 is detected “not failed.”

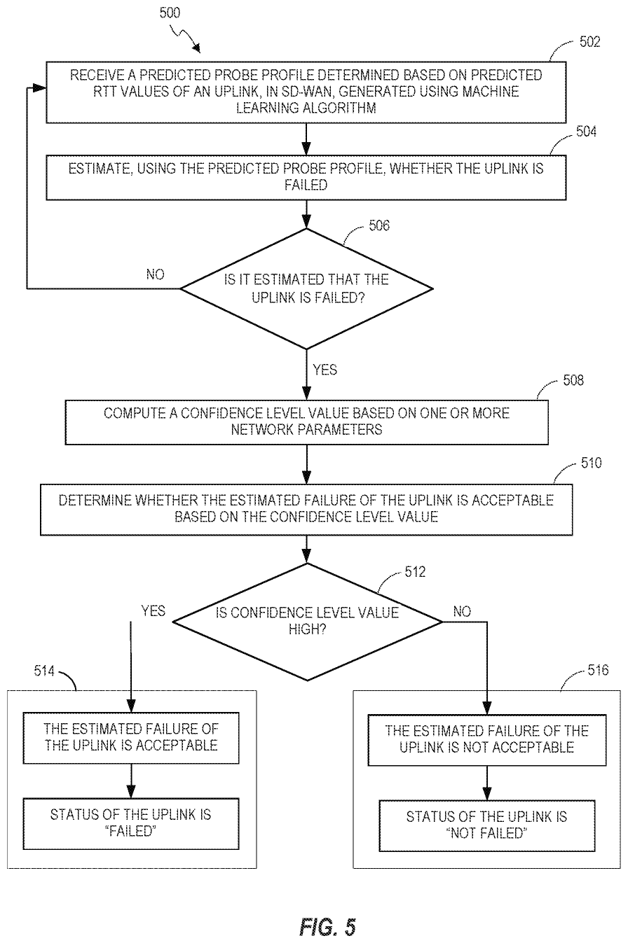

The instructions 406-412 may include various instructions to execute at least a part of the method described in FIG. 5 (described below). Also, although not shown in FIG. 4, the machine-readable medium 404 may also include additional program instructions to perform various other method blocks described in FIG. 5.

FIG. 5 is a flowchart illustrating an example method for detecting a status of an uplink in an SD-WAN. Method 500 may be stored as instructions in a memory and executed by a processing circuitry of a computing device such as an SD-WAN device. In some examples, method 500 may be executed by a branch gateway of a SD-WAN. Additionally, implementation of method 500 is not limited to such examples. Although the flowchart of FIG. 5 shows a specific order of performance of certain functionalities, method 500 is not limited to such order. For example, the functionalities shown in succession in the flowchart may be performed in a different order, may be executed concurrently or with partial concurrence, or a combination thereof.

In block 502, a predicted probe profile that is determined based on predicted RTT values of an uplink is received. The predicted RTT values of the uplink may be generated using a machine learning algorithm based on training data gathered over a predetermined period of time. A predicted wait time and/or a predicted probe retry value may be determined based on the predicted RTT values using equations 1 and 2, respectively, to define the predicted probe profile. In an example, the predicted probe profile may be received from another device present in the SD-WAN or a cloud system.

In block 504, it may be estimated, using the predicted probe profile, whether the uplink is failed. In some examples, probing of the uplink may be performed using the predicted probe profile, and it may be determined whether a response to probing is received in accordance with the predicted probe profile. In an example, it may be determined whether a response to probing is received in a predicted wait time. In some examples, upon determining that a response to probing is received in accordance with the predicted probe profile, the failure of the uplink 110 is not estimated (‘NO’ at block 506). In these instances, probing of the uplink may continue using predicted probe profiles (generated periodically) for tracking a status of the uplink. In other examples, upon determining that no response to probing is received in accordance with the predicted probe profile, the failure of the uplink is estimated (‘YES’ at block 506).

In response to estimating failure of the uplink, in block 508, a confidence level value may be computed based on one or more network parameters. In an example, the confidence level value may be computed based on RTT, jitter and packet-loss. In an example, the confidence level value may be calculated using equation 3.

In block 510, it may be determined whether the estimated failure of the uplink is acceptable based on the confidence level value to detect a status of the uplink. In some examples, it may be determined whether the confidence level value is high (i.e., higher than a predetermined threshold value of confidence level for an application). In instances when the confidence level value is high (‘YES’ at block 512), it may be determined that the estimated failure of the uplink is acceptable, in block 514. Accordingly, a status of the uplink is detected “failed.” In instances when the confidence level value is not high (‘NO’ at block 512), the estimated failure of the uplink is not acceptable, in block 516. In such examples, a status of the uplink 110 is detected “not failed.”

A software defined wide area network (SD-WAN) is a SDN that controls the interaction of various sites of a WAN. Each site may have one or more LANs, and LANs connect to one another via WAN uplinks. Some WAN uplinks are dedicated lines (e.g. MPLS), and others are shared routes through the Internet (e.g. DSL, T1, LTE, 5G, etc.). An SD-WAN dynamically configures the WAN uplinks and data traffic passing through the WAN uplinks to effectively use the resources of the WAN uplinks.

Branch gateways are network infrastructure devices that are placed at the edge of a branch LAN. Often branch gateways are routers that interface between the LAN and a wider network, whether it be directly to other LANs of the WAN via dedicated network links (e.g. MPLS) or to the other LANs of the WAN via the Internet through links provided by an Internet Service Provider connection. Many branch gateways can establish multiple uplinks to the WAN, both to multiple other LAN sites, and also redundant uplinks to a single other LAN site. Branch gateways also often include network controllers for the branch LAN. In such examples, a branch gateway in use in a SD-WAN may include a network controller that is logically partitioned from an included router. The network controller may control infrastructure devices of the branch LAN, and may receive routing commands from a network orchestrator.

An administrator is a person, network service, or combination thereof that has administrative access to network infrastructure devices and configures devices to conform to a network topology. In an example, the administrator is a person expert in the domain.

Processing circuitry is circuitry that receives instructions and data and executes the instructions. Processing circuitry may include application specific integrated circuits (ASICs), field programmable gate arrays (FPGAs), microcontrollers, central processing units (CPUs), graphics processing units (GPUs), microprocessors, or any other appropriate circuitry capable of receiving instructions and data and executing the instructions. Processing circuitry may include one processor or multiple processors. Processing circuitry may include caches. Processing circuitry may interface with other components of a device, including memory, network interfaces, peripheral devices, supporting circuitry, data buses, or any other appropriate component. Processors of a processing circuitry may communicate to one another through shared cache, interprocessor communication, or any other appropriate technology.

Memory is one or more non-transitory computer-readable medium capable of storing instructions and data. Memory may include random access memory (RAM), read only memory (ROM), processor cache, removable media (e.g. CD-ROM, USB Flash Drive), storage drives (e.g. hard drive (HDD), solid state drive (SSD)), network storage (e.g. network attached storage (NAS)), and/or cloud storage. In this disclosure, unless otherwise specified, all references to memory, and to instructions and data stored in memory, can refer to instructions and data stored in any non-transitory computer-readable medium capable of storing instructions and data or any combination of such non-transitory computer-readable media.

The features of the present disclosure can be implemented using a variety of specific devices that contain a variety of different technologies and characteristics. As an example, features that include instructions to be executed by processing circuitry may store the instructions in a cache of the processing circuitry, in random access memory (RAM), in hard drive, in a removable drive (e.g. CD-ROM), in a field programmable gate array (FPGA), in read only memory (ROM), or in any other non-transitory, computer-readable medium, as is appropriate to the specific device and the specific example implementation. As would be dear to a person having ordinary skill in the art, the features of the present disclosure are not altered by the technology, whether known or as yet unknown, and the characteristics of specific devices the features are implemented on. Any modifications or alterations that would be required to implement the features of the present disclosure on a specific device or in a specific example would be obvious to a person having ordinary skill in the relevant art.

Although the present disclosure has been described in detail, it should be understood that various changes, substitutions and alterations can be made without departing from the spirit and scope of the disclosure. Any use of the words “may” or “can” in respect to features of the disclosure indicates that certain examples include the feature and certain other examples do not include the feature, as is appropriate given the context. Any use of the words “or” and “and” in respect to features of the disclosure indicates that examples can contain any combination of the listed features, as is appropriate given the context.

Phrases and parentheticals beginning with “e.g.” or “i.e.” are used to provide examples merely for the purpose of clarity. It is not intended that the disclosure be limited by the examples provided in these phrases and parentheticals. The scope and understanding of this disclosure may include certain examples that are not disclosed in such phrases and parentheticals

The foregoing description of various examples has been presented for purposes of illustration and description. The foregoing description is not intended to be exhaustive or limiting to the examples disclosed, and modifications and variations are possible in light of the above teachings or may be acquired from practice of various examples. The examples discussed herein were chosen and described in order to explain the principles and the nature of various examples of the present disclosure and its practical application to enable one skilled in the art to utilize the present disclosure in various examples and with various modifications as are suited to the particular use contemplated. The features of the examples described herein may be combined in all possible combinations of methods, apparatus, modules, systems, and computer program products.

We/I claim:

1. A method, comprising:
receiving a predicted probe profile determined based on predicted round trip time (RTT) values, of an uplink, in a software-defined wide area network (SD-WAN), generated using a machine learning algorithm;
estimating, using the predicted probe profile, whether the uplink is failed;
in response to estimating that the uplink is failed, computing a confidence level value based on one or more network parameters for the uplink, the confidence level value representing an accuracy of estimated failure; and
determining whether the estimated failure of the uplink is acceptable based on the confidence level value to detect a status of the uplink.

2. The method of claim 3, wherein the predicted RTT values are determined based on RTT values gathered in response to probing the uplink for a predetermined period of time.

3. The method of claim 1, wherein estimating whether the uplink is failed comprises
performing probing, using the predicted probe profile, through the uplink; and
determining whether a response to the probing is not received in accordance with the predicted probe profile.

4. The method of claim 3, wherein determining whether the response to the probing is received in accordance with the predicted probe profile comprises determining whether the response to the probes is received within a wait time in accordance with the predicted probe profile, wherein the wait time defines a total time to be elapsed in performing probing before estimating failure of the uplink.

5. The method of claim 1, wherein the predicted probe profile is received from a management device present in the SD-WAN or a cloud system coupled to the SD-WAN.

6. The method of claim 1, wherein the one or more network parameters comprise RTT, jitter, or packet loss.

7. The method of claim 1, wherein the confidence level value is computed using a baseline value of the one or more network parameters.

8. The method of claim 7, wherein the baseline value of the one or more network parameters comprises a most frequent value, a maximum value, a mean value or a median value identified for the network parameter.

9. The method of claim 1, wherein determining whether the estimated failure of the uplink is acceptable comprise determining whether the confidence level value is higher than a predetermined threshold value of confidence level for an application.

10. The method of claim 1, wherein
upon determining that the estimated failure of the uplink is acceptable, detecting that the status of the uplink is failed.

11. The method of claim 1, wherein
upon determining that the estimated failure of the uplink is not acceptable, the status of the uplink is not failed.

12. A non-transitory machine-readable medium containing a set of instructions executable by a processing circuitry to:
receive a predicted probe profile determined based on predicted round trip time (RTT) values, of an uplink, in a software-defined wide area network (SD-WAN), generated using a machine learning algorithm;
estimate, using the predicted probe profile, whether the uplink is failed;
in response to estimating that the uplink is failed, compute a confidence level value based on network parameters including RTT, jitter and packet-loss of the uplink, the confidence level value representing an accuracy of estimated failure; and
determine whether the estimated failure of the uplink is acceptable based on the confidence level value to detect a status of the uplink.

13. The machine-readable medium of claim 12, wherein the predicted RTT values are determined based on RTT values gathered in response to probing the uplink for a predetermined period of time.

14. The machine-readable medium of claim 12, wherein the instructions to estimate whether the uplink is failed comprises instructions to:
perform probing, using the predicted probe profile, through the uplink; and
estimate that the uplink is failed when no response to probing the uplink is received in accordance with the predicted probe profile.

15. The machine-readable medium of claim 12, wherein the instructions to determine whether the response to the probing is received in accordance with the predicted probe profile comprise instructions executable by the processing circuitry to determine whether the response to the probes is received within a wait time in accordance with the predicted probe profile, wherein the wait time defines a total time to be elapsed in performing probing before estimating failure of the uplink.

16. The machine-readable medium of claim 12, wherein the confidence level value is computed using a baseline value of the one or more network parameters.

17. The machine-readable medium of claim 16, wherein the baseline value of each network parameter comprises a most frequent value, a maximum value, a mean value or a median value identified for the network parameter.

18. The machine-readable medium of claim 12, wherein the instructions to determine comprise instructions to determine whether the confidence level value is higher than a predetermined threshold value of confidence level for an application.

19. A branch gateway in an SD-WAN, comprising:
a processing circuitry; and
a machine-readable medium including instructions that, when executed on the processing circuitry, cause the device to:
receive a predicted probe profile determined based on predicted round trip time (RTT) values, of an uplink, in the SD-WAN, generated using a machine learning algorithm;
estimate, using the predicted probe profile, whether the uplink is failed;
in response to estimating that the uplink is failed, compute a confidence level value based on one or more network parameters of the uplink, the confidence level value representing an accuracy of estimated failure; and
determine whether the estimated failure of the uplink is acceptable based on the confidence level value to detect a status of the uplink.

20. The device of claim 19, wherein the uplink comprises a communication channel based on one of Multiprotocol Label Switching (MPLS), 4G LTE, 5G LTE, incorporated your suggestions or broadband Internet.
